(19) United States
(12) Patent Application Publication
(10) Pub. No.: US 2011/0224887 A1
(43) Pub. Date: Sep. 15, 2011

(54) THROTTLE VALVE CONTROLLER FOR AN INTERNAL COMBUSTION ENGINE

(75) Inventor: Torsten MUELLER, Russelsheim (DE)

(73) Assignee: GM GLOBAL TECHNOLOGY OPERATIONS LLC, Detroit, MI (US)

(21) Appl. No.: 13/045,717

(22) Filed: Mar. 11, 2011

(30) Foreign Application Priority Data
Mar. 12, 2010 (DE) 102010011240.2

(51) Int. Cl. F02D 41/12; F02D 28/00

(52) U.S. Cl. 701/103; 123/325

(57) ABSTRACT

A throttle valve controller is provided for an internal combustion engine, an electronic engine controller, via which an overrun cutoff of the fuel supply of the engine, is controllable, a throttle valve, which is displaceable using at least one electrical positioning motor, and a gas pedal having at least one potentiometer for recognizing the gas pedal position are provided. The throttle valve controller, if an overrun cutoff is activated and the position of the gas pedal is unchanged or reducing, brings the throttle valve using the positioning motor into a position in which the throttle valve throttles the gas stream flowing through it less than would be the case if the overrun cutoff were not activated in the respective gas pedal position.

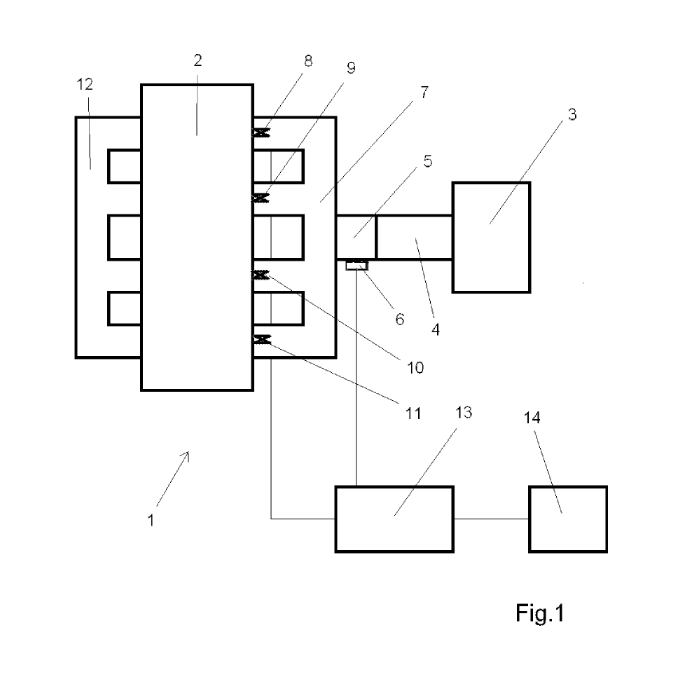

### CROSS-REFERENCE TO RELATED APPLICATION

This application claims priority to German Patent Application No. 102010011240.2, filed Mar. 12, 2010, which is incorporated herein by reference in its entirety.

### TECHNICAL FIELD

The technical field relates to a throttle valve controller for an internal combustion engine. The technical field also relates to an electronic engine controller, using which an overrun cutoff of the fuel supply of the engine is controllable, a throttle valve, which is displaceable using at least one actuator, for example, in the form of an electrical positioning motor, and a gas pedal.

### BACKGROUND

Throttle valve controllers are typically designed in such a way that the positioning of the throttle valve is performed according to a gas pedal provided for controlling the engine as a function of its position. Thus, for example, this means that when the gas pedal is returned into its rest position during driving operation and the overrun cutoff is activated by the engine controller, the throttle valve is moved into an essentially closed state. This results in maximum deceleration action of the internal combustion engine in overrun operation when the gas pedal is actuated hardly or not at all. This mode of operation of the throttle valve controller was heretofore typically desirable, since the engine is to have maximum brake action when the “gas” is taken away, i.e., when the gas pedal is not actuated, and the overrun cutoff responds.

Modern internal combustion engine concepts provide an electronic engine controller which has an overrun cutoff. This throttles or closes the fuel supply to injection valves of the engine under specific conditions, in particular when the engine is in overrun operation, a gear is engaged, and the gas pedal is essentially not actuated. For this purpose, the gas pedal is provided with at least one potentiometer for recognizing the gas pedal position. However, in the more recent past, energy-saving concepts and concepts for CO2 reduction have come more and more into the foreground, which also often include voltage-regulated generators (RVC generators (regulated voltage control)), for example. These generators may be controlled and used in such a way, for example, that they only perform conversion into electrical energy, or at least do so in amplified form, when the overrun cutoff is activated. However, they then convert more into electrical energy than conventional generators in normal operation and therefore also generate a higher braking or deceleration torque. Therefore, sufficient deceleration can already be performed solely by the use of such a generator.

It is at least one object to specify a throttle valve controller for an internal combustion engine having overrun cutoff, which is optimized for use in connection with energy-saving concepts of the internal combustion engine. In addition, other desirable features and characteristics will become apparent from the subsequent summary and detailed description, and the appended claims, taken in conjunction with the accompanying drawings and this background.

### SUMMARY

A throttle valve controller is provided that is implemented, in the case of activated overrun cutoff and unchanged or reducing gas pedal position, to bring the throttle valve using the positioning motor into a position in which the throttle valve throttles the gas stream flowing through it less than would be the case if the overrun cutoff were not activated in the respective gas pedal position.

Modern control concepts for a vehicle internal combustion engines provide energy-saving or CO2-saving concepts more and more frequently, which may include voltage-regulated generators, so-called RVC generators, for example. Using these or other technical concepts, in overrun operation with activated overrun cutoff of the engine, i.e., blocked fuel supply, as much as possible of the kinetic energy of the vehicle is converted into other forms of energy, in the example of the RVC generator into electrical energy. In the case of hybrid vehicles, vehicle batteries can be charged using special generators.

In all of these concepts it is fundamentally not required or even explicitly undesirable for the engine to apply a high braking force in overrun operation if the overrun cutoff is activated, since the kinetic energy of the vehicle is to be used in other ways as much as possible.

The throttle valve controller according to an embodiment of the invention begins here. It controls the throttle valve in this operating state of the engine in such a way that it is not extensively closed, which results in a relatively high deceleration action of the internal combustion engine, but rather opens the throttle valve. This is performed when the overrun cutoff of the internal combustion engine is activated and the gas pedal position is located in a range from unchanged position up to the rest position of the gas pedal or if the gas pedal is moved in this range, which is fed back to the throttle valve controller in one aspect of the invention using recognition means, in particular a potentiometer.

Therefore, if the overrun cutoff of the internal combustion engine is activated and the position of the gas pedal is reduced, i.e., the gas pedal is moved in the direction of the rest position or, for example, is left unchanged in the rest position, the throttle valve controller controls the throttle valve using a positioning motor in such a way that it throttles the gas stream flowing through it less than would be the case if the overrun cutoff were not activated in the respective gas pedal position. In other words, the throttle valve tends to be opened further than it would be opened outside the overrun operation in the respective gas pedal position. The deceleration action of the internal combustion engine is therefore reduced in this operating state, so that the kinetic energy of the vehicle is usable for other purposes.

This can advantageously go far enough, as provided according to one design of the invention, that the throttle valve is opened so far in the described operating state that it essentially does not throttle the gas stream flowing through it. In general, this means complete or nearly complete opening. Since the engine controller takes over essential aspects of the electronic controller of the internal combustion engine, in particular the overrun cutoff, in any case, it can advantageously also be used as the throttle valve controller according to the invention, as is provided according to one embodiment of the invention, so that no separate hardware is to be provided for the throttle valve controller.

In a further embodiment, a vehicle or a vehicle engine is equipped with a throttle valve controller having the above-mentioned features. Furthermore, a method for controlling a throttle valve of an internal combustion engine can also be provided to achieve the stated object, having the following steps: Performing an overrun cutoff of the fuel supply of the engine using an electronic engine controller, displacing the throttle valve using an actuator as a function of a gas pedal position, if the overrun cutoff is performed and a position of a gas pedal is unchanged or reducing, the throttle valve being brought via the displacement of the throttle valve controller by the actuator into a position in which the throttle valve throttles the gas stream flowing through it less than if the overrun cutoff were not activated in the respective gas pedal position. In an embodiment, the method can be refined by the recognition of the gas pedal position using detection means, in particular using a potentiometer

Moreover, a computer program is proposed, containing control commands for the controller of a computer for performing a method for controlling a throttle valve of an internal combustion engine, having the following steps: Performing an overrun cutoff of the fuel supply of the engine using an electronic engine controller, displacing the throttle valve using an actuator as a function of a gas pedal position, upon performance of overrun cutoff and unchanged or reducing position of a gas pedal, the throttle valve being brought via the displacement of the throttle valve controller by the actuator into a position in which the throttle valve throttles the gas stream flowing through it less than if the overrun cutoff were not performed in the respective gas pedal position.

Finally, a storage medium is provided in accordance with an embodiment, which is coded using a machine-readable program code, the program code containing control commands for the controller of a computer for performing a method for controlling a throttle valve of an internal combustion engine, having the following steps: Performing an overrun cutoff of the fuel supply of the engine using an electronic engine controller, displacing the throttle valve using an actuator as a function of a gas pedal position. If overrun cutoff is performed and the position of a gas pedal is unchanged or reducing, the throttle valve is brought via the displacement of the throttle valve controller by the actuator into a position in which the throttle valve throttles the gas stream flowing through it less than if the overrun cutoff were not performed in the respective gas pedal position.

### BRIEF DESCRIPTION OF THE DRAWINGS

The present invention will hereinafter be described in conjunction with the following FIGURE showing a schematic view of an internal combustion engine for a vehicle in accordance with an embodiment of the invention.

### DETAILED DESCRIPTION

The following detailed description is merely exemplary in nature and is not intended to limit application and uses. Furthermore, there is no intention to be bound by any theory presented in the preceding background or summary or the following detailed description.

The internal combustion engine 1 has a cylinder head 2, in which combustion chambers are located, as in an engine block located underneath (not indicated in FIGURE). The air required for combustion is sucked in via an air filter 3 and an intake system 4. A throttle valve 5, which is movable using a positioning motor 6, is located in the intake system 4. Behind the throttle valve 5, the optionally throttled air stream enters a suction pipe 7, which branches the air into four branches for four combustion chambers of the internal combustion engine 1. This exemplary embodiment is one for a four-cylinder internal combustion engine; of course, but can also be used for internal combustion engines having different numbers of cylinders, for example, in three-cylinder or six-cylinder engines.

At the ends of the branches of the suction pipe 7 and shortly before the combustion chambers or their intake valves (not shown in the FIGURE), an injection valve 8, 9, 10, and 11 is located in each branch, using which fuel can be injected, so that combustion can occur in the combustion chambers. However, the injection valves can also be situated in the respective combustion chambers and inject fuel directly into the combustion chambers. The combusted fuel-air mixture is guided out of the internal combustion engine 1 using an exhaust manifold 12.

The internal combustion engine 1 is controlled using an electronic controller 13. In particular, it controls the throttle valve 5 using the electrical positioning motor 6 as well as the injection valves 8 to 11. A gas pedal module 14 is assigned to the electronic controller 13, which has a gas pedal and at least one potentiometer for recognizing the gas pedal position (not shown in the FIGURE). The throttle valve controller according to the invention uses the electronic controller 13 in particular, which is also used as the throttle valve controller, in addition to the throttle valve 5, the positioning motor 6, and the gas pedal module 14.

In driving operation, the electronic controller 13 controls the throttle valve 5 using the positioning motor and the injection valves 8 to 11 in such a way that an air-fuel mixture, which results in a drive torque of the desired dimension, is supplied to the internal combustion engine 1 as a function of the gas pedal position signaled by the gas pedal module 14. Driving situations occur in which the gas pedal position is significantly reduced or the gas pedal is no longer actuated at all, i.e., is in an idle position. In such situations and if further boundary conditions are present (such as: engine has speed above idle speed, gear is engaged, catalytic converter has an operating temperature in the desired range, etc.), the electronic controller 13 activates a so-called overrun cutoff, which causes the fuel supply to the internal combustion engine 1 to be stopped, in that the injection valves are activated appropriately so that they no longer inject fuel.

If an overrun cutoff is activated in such a way and if, in addition, the gas pedal position does not change or is even reduced (which the gas pedal module 14 signals to the electronic controller 13, the electronic controller 13, which is also used as the throttle valve controller, controls the throttle valve 5 via the positioning motor 6 in such a way that the throttle valve 5 throttles the gas stream flowing through it less than would be the case if the overrun cutoff were not activated in the respective gas pedal position. In other words, the tendency is to open the throttle valve further than it would be open outside the overrun operation in the respective gas pedal position. The throttle valve is preferably also completely or extensively opened in this operating state, so that it throttles the gas stream flowing through it little or not at all.

The deceleration action of the internal combustion engine is therefore reduced in this operating state, so that the kinetic energy of the vehicle is usable for other purposes, for example, to generate electrical energy using other means provided in the vehicle.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A throttle valve controller for an internal combustion engine, comprising:
an electronic engine controller configured to perform an overrun cutoff of the internal combustion engine;
an actuator;
a gas pedal; and
a throttle valve that is displaceable via the actuator and the gas pedal,
wherein if the overrun cutoff is performed and a position of the gas pedal is either unchanged or reducing, the throttle valve configured to displace into a second position by the actuator in which a gas stream is provided that is less then a second gas stream that would exist if the overrun cutoff were not activated in a respective pedal position of the gas pedal.

2. The throttle valve controller according to claim 1, further comprising a detector configured to detect the pedal position.

3. The throttle valve controller according to claim 2, wherein the detector is a potentiometer.

4. The throttle valve controller according to claim 1, wherein if the overrun cutoff is activated and the position of the gas pedal is either unchanged or reducing, the throttle valve is configured to displace into a third position by the actuator to provide essentially no gas stream.

5. The throttle valve controller according to claim 1, wherein if the overrun cutoff is activated and the position of the gas pedal is unchanged or reducing, the throttle valve is configured to displace into an essentially fully open position.

6. The throttle valve controller according to claim 1, wherein the electronic engine controller is configured to assume activation of the actuator if the overrun cutoff is activated and the position is unchanged or reducing.

7. A method for controlling a throttle valve of an internal combustion engine, comprising:
performing an overrun cutoff of a fuel supply of the internal combustion engine using an electronic engine controller; and
if the overrun cutoff is performed and a position of a gas pedal is unchanged or reducing, displacing the throttle valve into a second position with an actuator in which the throttle valve throttles a gas stream that is less than if the overrun cutoff were not performed in the respective gas pedal position.

8. The method according to claim 7, further comprising recognizing the gas pedal position using a detector.

9. The method according to claim 8, wherein the detector is a potentiometer.

10. The method according to claim 7, further comprising displacing the throttle valve into a third position by the actuator to provide essentially no gas stream if the overrun cutoff is activated and the position of the gas pedal is either unchanged or reducing.

11. The method according to claim 7, further comprising displacing the throttle valve into an essentially fully open position if the overrun cutoff is activated and the position of the gas pedal is unchanged or reducing,

12. The method according to claim 7, further comprising assuming activation of the actuator by the electronic engine controller if the overrun cutoff is activated and the gas pedal position is unchanged or reducing.

13. A computer readable medium embodying a computer program product, said computer program product comprising:
a control program for controlling a throttle valve of an internal combustion engine, the control program configured to:
perform an overrun cutoff of a fuel supply of the internal combustion engine using an electronic engine controller; and
if the overrun cutoff is performed and a position of a gas pedal is unchanged or reducing, displace the throttle valve into a second position with an actuator in which the throttle valve throttles a gas stream that is less than if the overrun cutoff were not performed in the respective gas pedal position.

14. The computer readable medium embodying the computer program product according to claim 13, the control program further configured to receive the gas pedal position from a detector.

15. The computer readable medium embodying the computer program product according to claim 14, wherein the detector is a potentiometer.

16. The computer readable medium embodying the computer program product according to claim 13, the control program further configured to displace the throttle valve into a third position by the actuator to provide essentially no gas stream if the overrun cutoff is activated and the position of the gas pedal is either unchanged or reducing,

17. The computer readable medium embodying the computer program product according to claim 13, that the control program further configured to displace the throttle valve into an essentially fully open position if the overrun cutoff is activated and the position of the gas pedal is unchanged or reducing,.

18. The computer readable medium embodying the computer program product according to claim 13, the control program further configured to assume activation of the actuator with the electronic engine controller if the overrun cutoff is activated and the gas pedal position is unchanged or reducing.
